(19) United States
(12) Patent Application Publication
(10) Pub. No.: US 2004/0156155 A1
(43) Pub. Date: Aug. 12, 2004

(54) Residual current device with double grounded neutral fault detection

(76) Inventor: Patrick Ward, Ballinasloe (IE)

Correspondence Address: NATH & ASSOCIATES, PLLC, Sixth Floor, 1030 15th Street, N.W., Washington, DC, 20005, US

(21) Appl. No.: 10/774,537

(22) Filed: Feb. 10, 2004

(30) Foreign Application Priority Data
Feb. 12, 2003 (IE) S20030096
May 23, 2003 (IE) S20030395

(51) Int. Cl. H02H 3/00

(52) U.S. Cl. 361/42

(57) ABSTRACT

A residual current device includes a current transformer CT1 for sensing a differential current flowing in mains supply live L and neutral N conductors and a residual current actuator RCA for disconnecting the supply from a load when the differential current exceeds a predetermined level. The device also includes a circuit for detecting a double grounded neutral fault NF. Such circuit causes a current IZ to flow between the live and neutral conductors on the load LD side of the current transformer, such current being at least intermittently of sufficiently high amplitude and duration as to cause disconnection of the supply by the component of the current IZ flowing through the current transformer in the presence of a double grounded neutral fault.

This invention relates to a residual current device (RCD) with means for detecting a double grounded neutral fault.

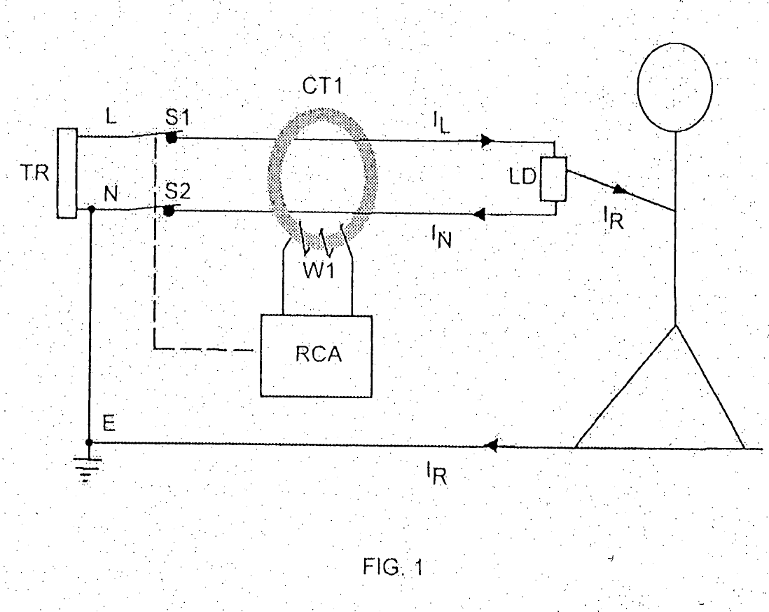

FIG. 1 represents an electrical installation which is protected by an RCD (also known as a Ground Fault Interrupter, GFI). The circuit of FIG. 1 represents a typical single phase TN installation comprising live L and neutral N conductors supplying a load LD, for example a domestic appliance. The transformer TR converts the high voltage from the electricity distribution system (not shown) to the normal low mains voltage of, for example, 230v or 110v. The supply neutral is connected directly to earth, and a solid earth conductor E is distributed throughout the installation. The installation is protected by an RCD as shown.

Under normal conditions, a current I_{L} flows from the supply in the live conductor L to the load and returns to the supply as I_{N} in the neutral conductor N. The RCD includes a current transformer CT1 through which the live and neutral conductors pass on their way to and from the load LD, and constitute the primary windings of CT1. CT1 has a secondary winding W1 whose output is connected to a residual current actuator RCA. Normally, in the absence of a residual current, the currents I_{L} and I_{N} in the conductors L and N are the same magnitude but flow in opposite directions, and as a result the vector sum of these currents is zero at CT1 and no current is induced into the secondary winding W1.

However, if a person touches a live part, as indicated at the right hand side of FIG. 1, a current I_{R} will flow through the person's body to earth and return to the supply via the earth return path. The current I_{L} will now be greater than I_{N} and CT1 will produce a resultant output from W1 in response to this differential or residual current. This output will be detected by the residual current actuator RCA, and if above a predetermined level, will cause the actuator to open contacts S1 and S2 and disconnect the supply from the load and thereby provide protection. This type of RCD is extremely well-known and no further details are necessary.

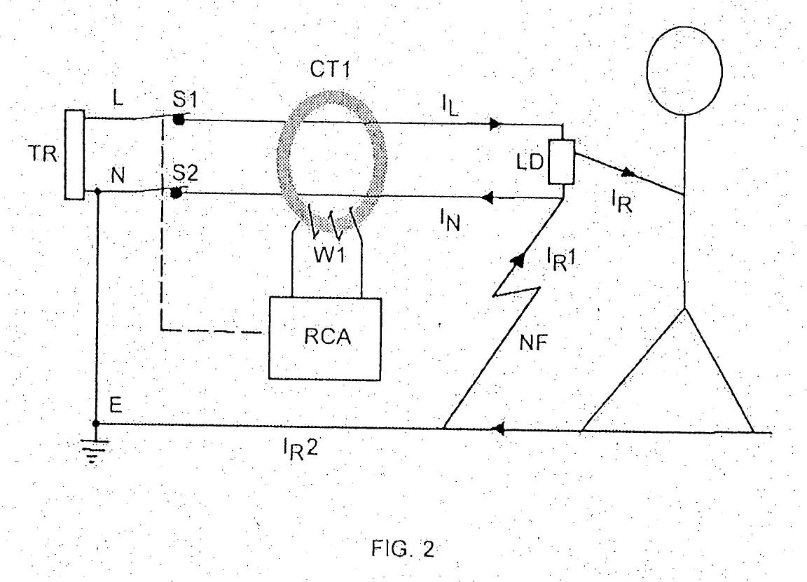

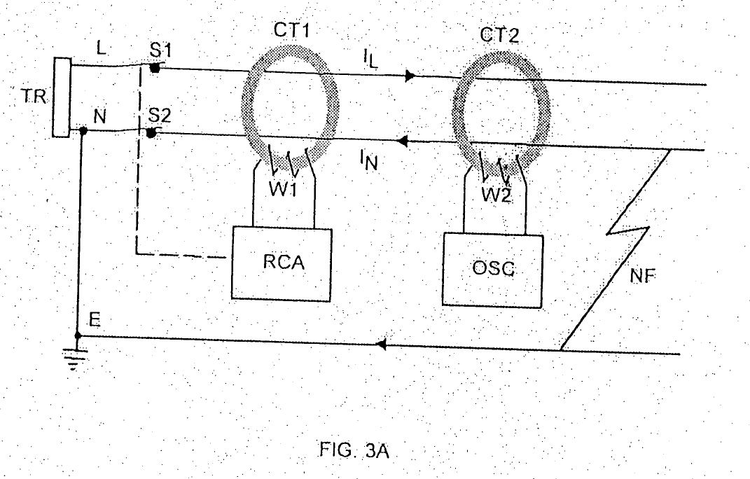

The key factor in the ability of the RCD to detect a residual current and provide protection is the connection of the supply neutral conductor to earth at the origin of the installation. However, the earthed neutral arrangement can also be a factor in the RCD being prevented from performing this vital task. FIG. 2 shows how a second connection between N and E can disable the RCD.

In the circuit of FIG. 2, the load side neutral conductor N has been inadvertently connected to earth. Such a condition is often referred to as a double grounded neutral fault, and is indicated by NF in the drawings. Such a fault could occur due to an insulation breakdown or mis-wiring of the load. Under this condition, the current I_{R} flowing through the body will see a junction at the load side neutral-earth connection. The current I_{R} will now split into two components, I_{R}1 and I_{R}2, with I_{R}1 returning to the supply via the neutral conductor N as shown. Thus, CT1 will now see a residual current of magnitude I_{R}2 instead of the full body current I_{R}. If the current I_{R}2 is below the actuation threshold of the RCD, the RCD will not trip and the fault current will be allowed to flow through the body without interruption.

The division of the current I_{R} will be determined by the relative impedances of the earth and neutral return paths. In a TN installation, it is not uncommon for the earth conductor to be of smaller cross sectional area than that of the neutral conductor, in which case the earth return impedance will be greater than that of the neutral, possibly several times greater, with the result that a relatively small portion of the earth fault current will be seen as a residual current by the RCD under a double grounded neutral fault condition. However, on a TT installation, this problem is compounded by the fact that such installations generally do not use a solid conductor throughout the earth return path. In such installations, the neutral is usually connected to earth at the origin of the installation, and a subsequent connection is made to earth at the load by way of an earth probe inserted into the ground. In such installations, the impedance of the earth return path is determined by the nature of the soil or ground in the earth return path, the length of the earth return path (which is sometimes indeterminate), and environmental factors such as wet or dry weather, etc. As a result, the impedance of the earth return path in TT installations will usually be measurable in ohms, and will often be of the order of tens of ohms. This can result in the earth return path having an impedance many times higher than that of the neutral conductor.

The division of the earth fault current between the neutral and earth paths as demonstrated in FIG. 2 results in the RCD seeing a level of residual current which is less than that of the earth fault current. To some extent, this may be interpreted as a reduction in the sensitivity of the RCD, which is the same as an increase in the trip level of the RCD, even though the actual trip level of the RCD may not have changed. However, a double grounded neutral fault can also reduce the actual sensitivity of the RCD with the result that two factors can adversely impact on the performance of the RCD.

Under a grounded neutral fault condition, a conductive path is formed from the supply neutral to the load through the grounded neutral fault connection through the earth return path and back to the neutral via the grounded supply neutral point as shown in FIG. 2. This path forms a loop which is seen as a tertiary winding by CT1. The impedance of this tertiary winding will act as a load on CT1 with the result that the previous trip point of the RCD will be shifted from its initial residual current level to a higher level. The increase in the trip point will depend on the impedance values of the tertiary and secondary windings as seen by CT1, and for certain current transformers the upward shift in the trip point will be far greater than the simple mathematical analysis of FIG. 2 might indicate. Therefore, in practice, two factors will determine the actual trip current level of the RCD:

i) Division of the earth fault current between the neutral and earth return paths.

ii) Desensitisation of the CT.

In each type of installation, TN and TT, double grounding of the neutral will result in an increase in the residual current level required to trip the RCD with a resultant increased risk of non-functioning of the RCD under an earth fault condition. This risk is perceived as being unacceptable in some countries with the result that they have a requirement that RCDs fitted in such countries are required to trip automatically in response to a double grounded neutral fault or be able to continue to provide protection under such a fault condition.

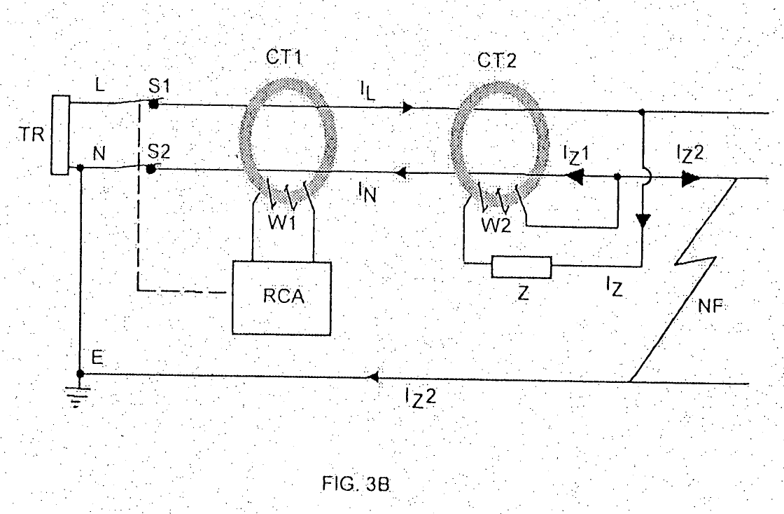

Means to detect a double grounded neutral condition are well known, and generally require the use of a second CT in the RCD as demonstrated in FIGS. 3A and 3B.

The double grounded neutral fault detection circuit of FIG. 3A comprises a second current transformer CT2 which has a multiple turn winding W2 and an oscillator circuit OSC which induces a signal into the winding W2. In the event of a ground fault at the load neutral, the neutral and earth return paths will form a single loop, and the signal induced into W2 will in turn be induced into this loop. The oscillator signal will be seen by CT1 as a residual current, causing the RCD to trip.

The double grounded neutral fault detection circuit of FIG. 3B comprises a second current transformer CT2 with a multiple turn winding W2 and an impedance Z which is connected in series with W2 and thence between the live and neutral conductors. Under normal conditions a current I_{Z} flows through W2, but in the absence of a double grounded neutral condition CT2 does not have a closed secondary winding. However, under a double grounded neutral condition, the neutral and earth return paths form a single loop which acts as a secondary winding on CT2. The current I_{Z} induces a current into this loop, and this current in turn is detected by CT1 as a residual or imbalance current, causing automatic tripping of the RCD.

Variations on the techniques shown in FIGS. 3A and 3B are sometimes used, but almost all conventional arrangements for detection of a double grounded neutral fault involve the use of a current transformer or a voltage transformer. Transformers by their nature tend to be the most bulky and expensive components used in RCDs, and obviating the need for a transformer would provide considerable benefits to RCD manufacturers.

It is the purpose of the present invention to provide a new, simple and cost effective means for detection of a double grounded neutral condition.

According to the present invention there is provided a residual current device (RCD) including means for sensing a differential current flowing in mains supply live and neutral conductors and for disconnecting the supply from a load when the differential current exceeds a predetermined level, the device further including a circuit for detecting a double grounded neutral fault comprising means for causing a current to flow between the live and neutral conductors, such current being, at least intermittently, of sufficient amplitude and duration as to cause disconnection of the supply by the component of the current detected by the sensing means in the presence of a double grounded neutral.

In one embodiment the current is alternately on and off, the amplitude and duration of the current during each on period being sufficient to cause said disconnection.

Alternately, however, the current may alternate between periods of relatively higher and lower amplitude, the amplitude and duration of the current in each higher amplitude period being sufficient to cause said disconnection.

Preferably the double grounded neutral fault detecting circuit does not include a transformer.

Embodiments of the invention will now be described, by way of example, with reference to the accompanying drawings, in which:

FIGS. 1 to 3B, previously described, illustrate various prior art RCDs;

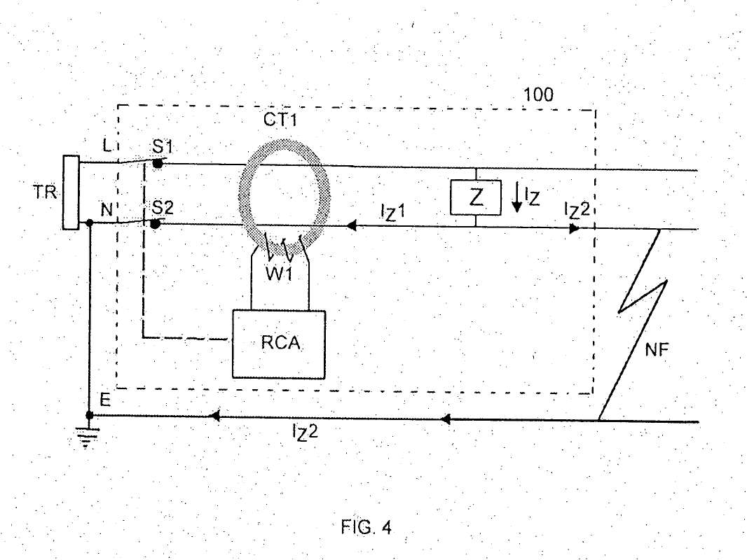

FIG. 4 is a circuit diagram of a first embodiment of the invention;

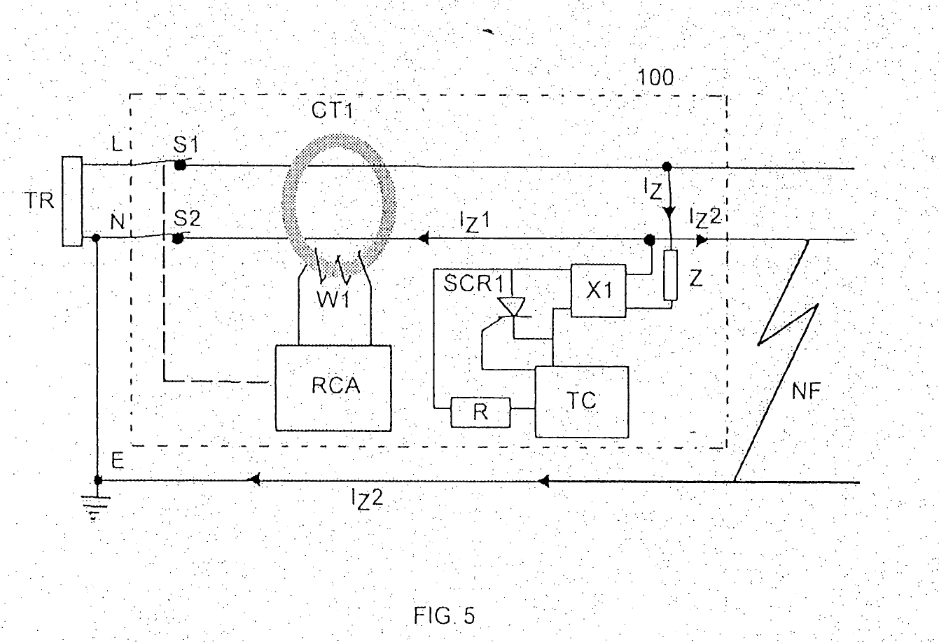

FIG. 5 is a circuit diagram of a second embodiment of the invention;

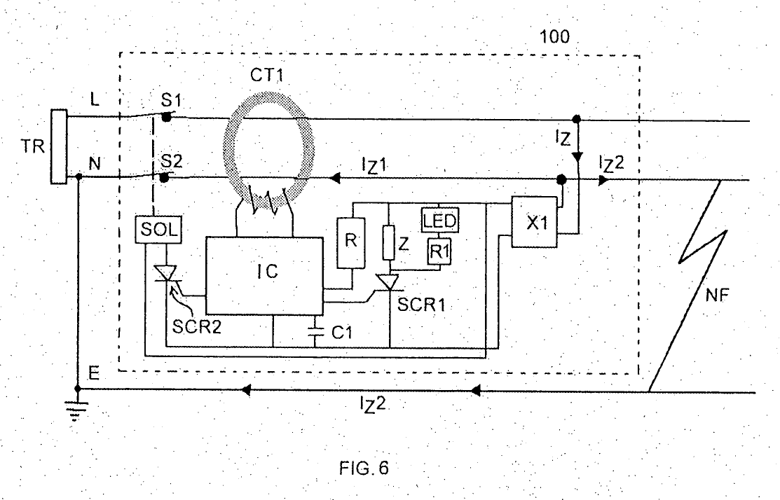

FIG. 6 is a circuit diagram of a third embodiment of the invention;

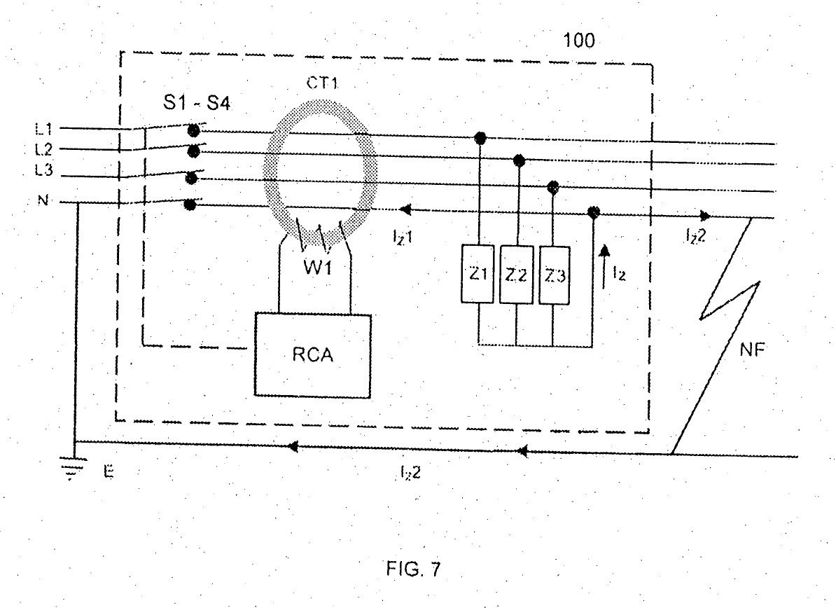

FIG. 7 is a circuit diagram of a fourth embodiment of the invention; and

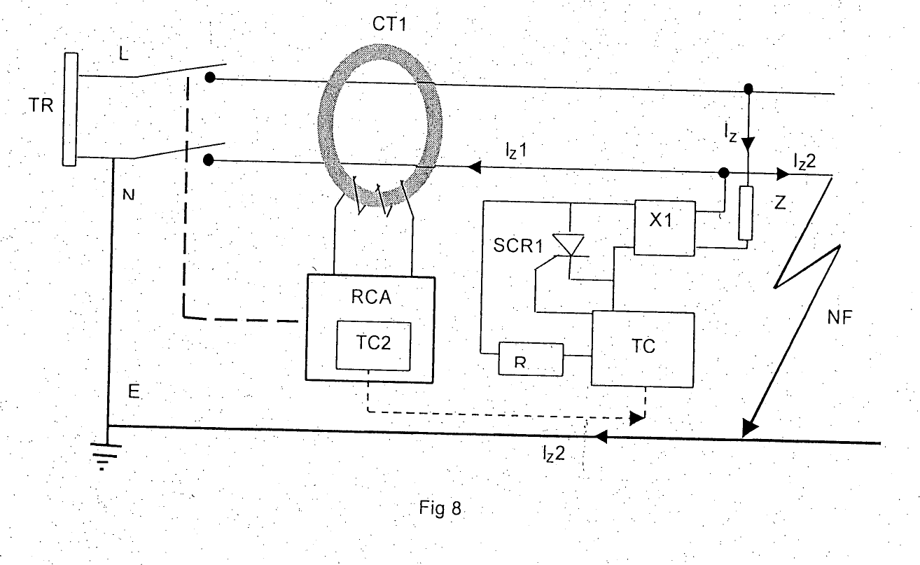

FIG. 8 is a circuit diagram of a fifth embodiment of the invention.

In an installation of the kind shown in FIG. 1, when a current flows through a load under a double grounded neutral condition, a portion of the load current will flow via the earth return path and be seen by CT1 as a residual current, and if this residual current is sufficiently large, the RCD will trip automatically. This automatic tripping of the RCD is not dependent on any dedicated double grounded neutral circuitry. However, if no load is connected or if the load is switched off and a double grounded neutral condition arises, automatic tripping will not occur, in which case the user will be exposed to a shock risk as shown in FIG. 2.

If a current of sufficient magnitude could be caused to flow continuously between live and neutral on the load side of CT1, automatic tripping of the RCD under a double grounded neutral condition could be assured. To ensure its availability to perform this function, the connection providing this current would need to be made internally within the RCD housing, otherwise it could be removed and the double grounded neutral fault detection means would be disabled.

Such an arrangement is shown in FIG. 4, where an impedance Z is connected between the live and neutral conductors L, N within the RCD housing 100 and a current I_{Z} is thereby caused to flow continuously between live and neutral conductors. In the event of a double grounded neutral fault NF as shown, two current paths will be formed, one being the original neutral return path and the other being the earth return path. Thus the current I_{Z} will split into two components, I_{Z}1 and I_{Z}2, the amplitude ratio of the two components being determined by the relative impedance of the earth and neutral return paths. The value of impedance Z can be selected so as to ensure that current I_{Z}2 is of sufficient magnitude to result in automatic tripping of the RCD for a given value of impedance in the earth return path.

If impedance Z were predominantly resistive and allowed a relatively high level of current I_{Z} to flow, this could result in problems of excessive power dissipation, heat, size, reliability, etc. These problems would also place a serious constraint on the maximum magnitude of current I_{Z}. These problems might make such a solution impractical in some cases. However, these problems can be mitigated by making impedance Z a substantially reactive component, such as a capacitor or inductor. By using a capacitor of suitable capacitance value, a relatively large value of current I_{Z} could flow without creating heat and power dissipation problems.

Alternatively, the above problems can be mitigated by allowing a relatively large current to flow intermittently for short periods. An embodiment is shown in FIG. 5.

The arrangement of FIG. 5 comprises an impedance Z, a bridge rectifier X1, a silicon controlled rectifier SCR1, a resistor R and a timer circuit stage TC, which may be in the form of discrete components or a dedicated timer IC such as the well known 555 timer series ICs. The timer circuit TC is powered from the mains supply via Z, X1 and R, the supply current to the timer circuit TC having a very low value, typically 1 mA. TC produces a continuous series of pulses to the gate of SCR1 at a set rate with set on and off times. When SCR1 is turned on by a pulse on its gate, it connects the impedance Z across the live and neutral conductors L, N via the bridge rectifier X1 with the result that a large current I_{Z} flows through impedance Z. In the presence of a double grounded neutral fault NF, this current splits into I_{Z}1 and I_{Z}2, with I_{Z}2 returning to the supply via the earth return path. Current I_{Z}2 is therefore seen by CT1 as a residual current, and if this current is above the trip threshold of the RCD, automatic tripping will occur.

The magnitude of I_{Z} can be made sufficiently large to ensure that the RCD will trip for a given value of impedance in the earth return path. To minimise power dissipation in Z, the off period of the pulses from the timer can be made substantially longer than the on periods. For example, the on period could be 40 mS combined with an off period of 1.2 seconds, giving a duty cycle of 1:300. The 40 mS on period would provide sufficient time to cause most RCDs to trip, and the duty cycle would result in a substantial reduction in the mean or average value of Iz. Assuming a current of 1 ampere were allowed to flow through the impedance Z for this period, the power dissipation in Z would be about 240 watts for a 240V installation. However, with a duty cycle of 1:300, impedance Z could be rated at 0.8W, which would enable it to be relatively compact and inexpensive.

If used on a TT system, and assuming that the earth return impedance were 30 times greater than that of the neutral return, a current Iz of about 1 ampere would cause a current of about 33 mA to flow in the earth return path, which would result in automatic tripping of most RCDs intended to provide personal shock protection.

As stated earlier, the double grounded neutral detection circuit should be inside the same housing 100 as the RCD proper—i.e. CT1, RCA and S1, S2—to avoid tampering.

The arrangement of FIG. 5 can be refined as shown in FIG. 6. Here, an integrated circuit IC, powered from the bridge rectifier X1, contains circuitry for detecting and evaluating a residual current. The IC turns on a second silicon controlled rectifier SCR2 to activate a relay or solenoid SOL when the residual current exceeds a certain threshold, thereby causing automatic opening of the contacts S1 and S2. The IC also contains an integral timing circuit which produces a series of output pulses at preset intervals. A capacitor C1 is charged by a current source within the IC, and when the voltage on C1 reaches a certain threshold, an output pulse is fed to SCR1 turning it on and causing the flow of current I_{Z}, thereby providing the double grounded neutral detection function as explained for FIG. 5. The time taken for C1 to reach the required threshold sets the off period for SCR1. The on period is set by discharging the voltage on C1 into the gate of SCR1 or via an internal impedance. The current flow into the gate of SCR1 may be regulated so as to control the rate of discharge of C1 and thereby ensure a desired on time for SCR1. The on time may be increased by adding an external impedance in series with the gate of SCR1. The off and on times can be changed by changing the value of C1.

The advantage of the arrangement of FIG. 6 is that the IC provides the normal residual current detecting functions, and the only additional components required to provide the double grounded neutral function are C1, SCR1, R and Z. This arrangement results in a very compact, low cost and flexible means for detection of a double grounded neutral fault.

As seen in FIG. 6 a light emitting diode LED or similar visual indicating device may be fitted in the circuit of SCR1 so as to provide a visual indication that the double grounded neutral circuit is functioning. As shown, the LED is connected in series with a current limiting resistor R1 in parallel with the impedance Z, so that the LED will flash each time SCR1 is turned on. The LED may also be connected in parallel with the SCR such that it is normally on and is turned off when the SCR is turned on. This visual indication may also be used to verify that the RCD is powered up and that power is available at the output. The power indicator may be used without the double grounded neutral circuit being fully activated, for example by using a high impedance value for Z so as to provide for visual indication on the LED only.

To further reduce space and cost, the bridge rectifier X1 may be replaced with a diode. This would result in pulsating DC current flow when SCR1 was turned on, which would be acceptable if the RCD part of the circuit is able to respond to such currents.

Although FIGS. 5 and 6 have described arrangements wherein the current through Z is alternately on and off, with the amplitude and duration of the current during each on period being sufficient to cause disconnection of the mains, other embodiments are possible. For example, the current through the impedance Z could alternate between periods of relatively higher and lower amplitude, the amplitude and duration of the current in each higher amplitude period being sufficient to cause said disconnection. The current amplitude during the periods of low amplitude would be sufficiently low that the average power dissipation would be within acceptable limits.

Also, if space permitted, it would be possible to connect a thermal switch in series with the impedance Z across the conductors L and N such that the closed contacts of the thermal switch opened automatically after a certain period of time due to the heat generated by the flow of current I_{Z} within the switch, the contacts reclosing automatically after the internal temperature of the switch had fallen below the automatic opening value. This intermittent opening and closing of the switch contacts would imitate the action of the electronic timer versions described above.

As described above, the arrangements of FIGS. 5 and 6 result in automatic tripping of the RCD on the occurrence of a double-grounded neutral condition. Referring now to FIG. 8, power dissipation in these circuits can be reduced further by disabling the timing circuit TC of FIG. 5 (or the corresponding components of the IC in FIG. 6) in the absence of a residual current, and only activating the timing circuit (or corresponding components) in the presence of a residual current. An enabling signal controlling the timing circuit is indicated by the dotted line from the RCA circuit to the timing circuit TC. The timing circuit TC will thus produce a train of pulses to SCR1 only when it receives the enabling signal from the RCA circuit and in the absence of this enabling signal, SCR1 will remain turned off.

It should be noted that although the double grounded neutral circuit results in desensitisation of the RCD, any residual current flow will result in some output from the CT which will be sensed by the RCA circuit. In FIG. 8, the RCA circuit further includes a timer circuit TC2. TC2 is arranged so that when a residual current is detected by the CT, it duty cycles the enabling signal with an interval between on-periods inversely proportional to the residual current. So, for lower level residual currents, the interval between enabling signal on periods is longer and vice versa. As explained, the enabling signal is sent from the RCA circuit to the timing circuit TC and thereby allows SCR1 to periodically conduct within the overall on period of the enabling signal.

In effect, SCR1 will be turned on at predetermined intervals by pulse trains with a limited number of gating pulses from the timing circuit TC. The enabling signal therefore regulates the timer circuit TC with regard to the interval between the pulse trains and the number of gating pulses contained in each pulse train.

This arrangement also has the advantage of further reducing power dissipation in the double grounded neutral detection circuit.

Power dissipation in Z can be further reduced by arranging for the sensitivity of the RCA circuit to be increased at the commencement of and for the duration of each pulse train, so as to make the RCD more responsive to any component of the current Iz that flows through the earth return path. To reduce the risk of nuisance tripping in response to standing residual currents on the installation which are below the trip threshold of the RCD, the increase in sensitivity may be made inversely proportional to the level of the standing residual current.

The invention is not confined to single phase installations, and the above embodiments can readily be adapted for use in multiphase circuits. For example, an embodiment equivalent to that of FIG. 4 is shown in FIG. 7 for a three phase installation having three phase (live) conductors Z1, L2 and L3 and a neutral conductor N. Current flows from each phase conductor to neutral N via respective impedances Z1, Z2 and Z3 to produce a combined current I_{Z}. Under normal conditions all of this current flows in the neutral return path. However, in the presence of a double grounded neutral fault, the current splits into IZ1 and IZ2 as before, and the component IZ1 flowing through CT1 is sensed and triggers the RCD.

It should also be noted that while the preferred embodiments have shown the disconnection of all supply conductors in the event of a fault, the invention may equally be implemented in single pole RCDs where only one conductor is disconnected, the purpose of the invention being only to disconnect the supply from a load.

The invention is not limited to the embodiments described herein which may be modified or varied without departing from the scope of the invention.

1. A residual current device (RCD) including means for sensing a differential current flowing in mains supply live and neutral conductors and for disconnecting the supply from a load when the differential current exceeds a predetermined level, the device further including a circuit for detecting a double grounded neutral fault comprising means for causing a current to flow between the live and neutral conductors, such current being, at least intermittently, of sufficient amplitude and duration as to cause disconnection of the supply by the component of the current detected by the sensing means in the presence of a double grounded neutral.

2. An RCD as claimed in claim 1, wherein the current is alternately on and off, the amplitude and duration of the current during each on period being sufficient to cause said disconnection.

3. An RCD as claimed in claim 1, wherein the current alternates between periods of relatively higher and lower amplitude, the amplitude and duration of the current in each higher amplitude period being sufficient to cause said disconnection.

4. An RCD as claimed in claim 2, wherein the periods for which the intermittent current flows is determined by a timing circuit powered from the live and neutral conductors.

5. An RCD as claimed in claim 4, wherein the timing circuit forms part of a single integrated circuit which also responds to a residual current above the predetermined level to initiate the disconnection of the supply.

6. An RCD as claimed in claim 1, wherein the current flows continuously through an impedance connected between the live and neutral conductors.

7. An RCD as claimed in claim 6, wherein the impedance is substantially reactive.

8. An RCD as claimed in claim 6, wherein a thermal switch is connected in series with the impedance.

9. An RCD as claimed in claim 1, further including means for providing a visual indication when the current is flowing.

10. An RCD as claimed in claim 1, wherein the double grounded neutral detection means is contained in a common housing with the sensing means.

11. An RCD as claimed in claim 1, wherein the double grounded neutral fault detecting circuit does not include a transformer.
